(19) United States
(12) Patent Application Publication
(10) Pub. No.: US 2003/0027001 A1
(43) Pub. Date: Feb. 6, 2003

(54) Anti-reflective and anti-static multi-layer thin film for display device

(76) Inventors: Tae Soo Kang, Gumi-si (KR); Je Choon Ryoo, Daegu (KR); Kyeong Keun Woo, Seoul (KR); Cha Hyun Ku, Gumi-si (KR); Jeong Hong Oh, Gumi-si (KR); Kyo Jeong Kim, Seoul (KR)

Correspondence Address: David A. Einhorn, Esq., Anderson Kill & Olick, P.C., 1251 Avenue of the Americas, New York, NY, 10020, US

(21) Appl. No.: 10/209,127

(22) Filed: Jul. 31, 2002

(30) Foreign Application Priority Data
Aug. 1, 2001 (KR) 2001-46548

(51) Int. Cl. B32B 17/06

(52) U.S. Cl. 428/432

(57) ABSTRACT

An anti-reflective and anti-static multilayer structure for display device, comprising a glass substrate, and an ITO layer, a first Nb₂O₅ layer, a first SiO₂ layer, a second Nb₂O₅ layer and a second SiO₂ layer, which are successively formed on the glass substrate, achieves good film adhesive strength, solidity and enhanced photoreflectance.

### FIELD OF THE INVENTION

The present invention relates to an antireflective and anti-static multilayer structure for use in a display device; and, more particularly, to a five-layered anti-reflective and anti-static coating on a glass substrate with an improved adhesion coefficient and strength.

### BACKGROUND OF THE INVENTION

Recently, a thin film coating is widely applied to a surface of a display device in order to prevent generation of static electricity, block electromagnetic radiation and reduce the reflection of external light. Such a thin film is normally made of at least 2 layers and 2 kinds of materials; and in order to enhance electrical and optical properties thereof, a large number of layers formed of various materials can be employed for the manufacture thereof. The multilayer thin film of this type is also required to have appropriate mechanical properties of, e.g., adhesion coefficient and strength.

Multilayer thin films for such purpose are generally fabricated by using various film forming techniques, such as spraying, deposition, coating, chemical deposition, and sputtering. The sputtering, which is one of the most generally employed film forming method, can be classified into one of a batch type sputtering, an inter-back sputtering and an in-line sputtering technique depending on the type of the way how loading and unloading substrates being carried out.

In the batch type sputtering, a substrate is directly loaded in a coating chamber and a surface thereof is coated with a thin film therein.

In the inter-back sputtering, a sub-chamber is provided for loading and unloading therethrough a substrate into and from a coating chamber in which the film formation is carried out.

In the in-line sputtering, a loading chamber and an unloading chamber are provided next to a coating chamber. A substrate is loaded into the coating chamber via the loading chamber to be processed and then the processed substrate is unloaded from the coating chamber via the unloading chamber.

In the field of manufacturing LCD and PDP, the above-described in-line sputtering technique is most widely used for coating a substrate surface with a SiO₂ layer and an ITO(Indium Tin Oxide) layer sequentially.

A prior art multilayer thin film produced by the in-line sputtering scheme is normally 4 layered structure including an ITO layer formed on an ordinary glass substrate.

FIG. 1 shows a conventional thin film having 4 layers, including an ITO layer 12, a first SiO₂ layer 13, a Nb₂O₅ layer 14, and a second SiO₂ layer 15 successively formed on a glass substrate 11.

The glass substrate 11 is normally composed of ordinary glass generally having an RMS(root mean square) roughness of 1.75˜2.09 Å and peak-to-valley surface roughness of 24.8˜40 Å. The thickness of the ITO layer 12, the first SiO₂ layer 13, the Nb₂O₅ layer 14, and the second SiO₂ layer 15 are respectively about 19 nm, 29 nm, 112 nm, and 90 nm.

Such a prior art multilayer thin film having 4 layers suffers from weak adhesive strength between layers, so that it cannot withstand impacts of strength of 1.5 KgF/cm² more than approximately 150 times, wherein the strength for the film is tested in such a manner that a sample is placed on a balance and is pressed by a cotton wad having contact surface of 10 cm×1 cm to scale 15 KgF. Also, the light reflectance of such conventional film is as high as about 0.27%.

### SUMMARY OF THE INVENTION

It is, therefore, an object of the present invention to provide an anti-reflective and anti-static multilayer structure, for use in a display device, having 5 layers with an improved adhesion property, film strength, and light reflecting property.

In accordance with the present invention, there is provided an anti-reflective and anti-static structure for a display device, comprising a glass substrate, and an ITO layer, a first Nb₂O₅ layer, a first SiO₂ layer, a second Nb₂O₅ layer, and a second SiO₂ layer successively formed in that order on the glass substrate.

### BRIEF DESCRIPTION OF THE DRAWINGS

The above and other objects and features of the present invention will become apparent from the following description of the preferred embodiment given in conjunction with the accompanying drawings, in which:

FIG. 1 schematically illustrates a prior art multi-layer structure; and

FIG. 2 schematically exhibits a multilayer structure in accordance with the preferred embodiment of the present invention.

### DETAILED DESCRIPTION OF THE PREFERRED EMBODIMENTS

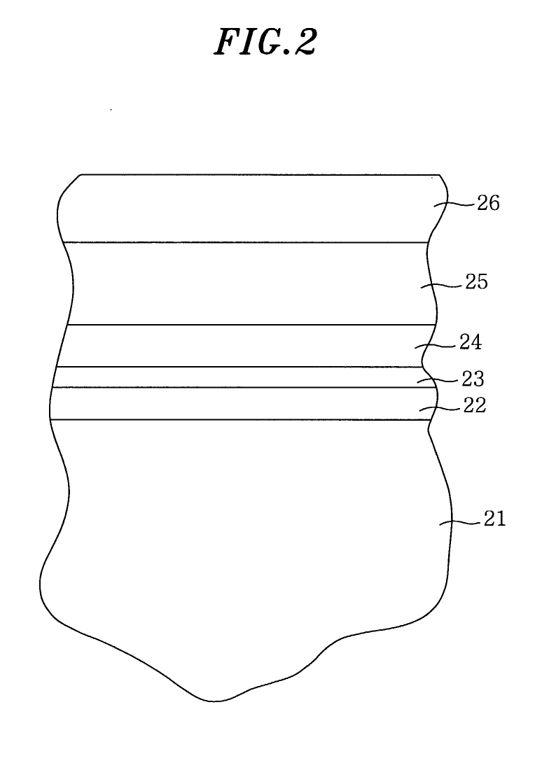

FIG. 2 illustrates a multilayer thin film having 5 layers including an ITO layer 22, a first Nb₂O₅ layer 23, a first SiO₂ layer 24, a second Nb₂O₅ layer 25, and a second SiO₂ layer 26 successively grown in that order on a glass substrate 21 in accordance with the preferred embodiment of the present invention.

In accordance with the preferred embodiment of the present invention, entire process is performed through the use of an in-line sputtering system. Particularly, the ITO layer 22 is formed by DC sputtering; and the Nb₂O₅ layers 23, 25 and SiO₂ layers 24, 26 are formed by PEM(Plasma Emission Monitor) controlled MF(Mid Frequency) reactive sputtering. The entire process is performed in an environment whose temperature is kept at about 15˜400° C. DC sputtering is the process most often used for large area commercial coating applications and the PEM control is used to obtain high stability at high deposition rates of the processes, controlling by regulating the ratio of collision numbers between the sputtered metal particles and the admitted reactive gas.

An ordinary glass, which is typically used for the glass substrate 11 in the prior art thin film forming process, may be used for the glass substrate 21, but in order to obtain greater film strength and improved surface property of the thin film, a surface-treated glass is preferably used. The surface-treated glass is obtained by polishing the surface of an ordinary glass. In the preferred embodiment of the present invention, the surface-treated glass has RMS surface roughness of 6.14 Å and peak-to-valley surface roughness of 106 Å.

The ITO layer 22 is deposited on the glass substrate 21 by DC sputtering using an ITO target in an atmosphere including argon(Ar) and oxygen with flow rates of 200 sccm and 3 sccm, respectively, for example. The thickness of the ITO layer 22 is preferably about 17 nm˜19 nm.

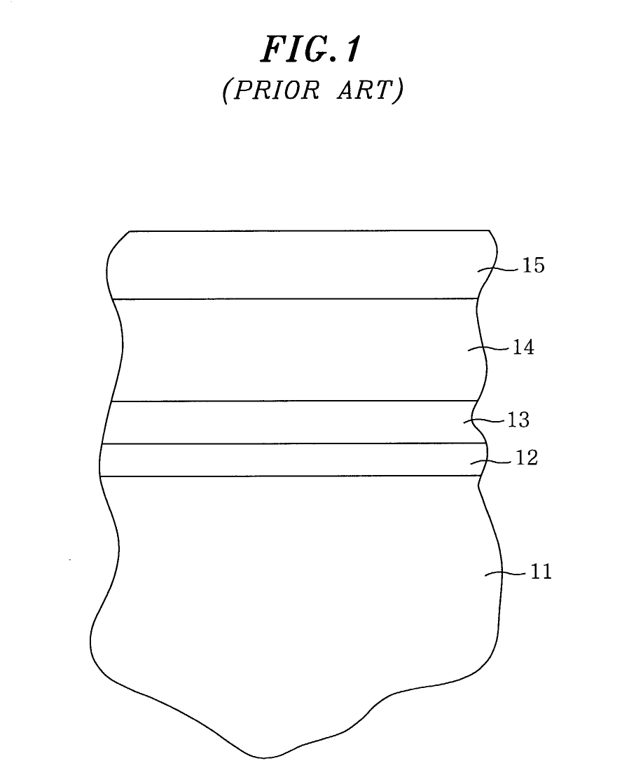

The first Nb₂O₅ layer 23 is deposited on the ITO layer 22 by PEM controlled reactive sputtering using a Niobium(Nb) target in an atmosphere including argon, and oxygen with flow rates of, e.g., about 80˜450 sccm and 120 sccm respectively. The thickness of the first Nb₂O₅ layer 23 is preferably about 3 nm to 5 nm. In the preferred embodiment of the present invention, the first Nb₂O₅ layer 23 having a thickness of about 3 nm and 5 nm is additionally deposited on the ITO layer 22, in contrast to the prior art film forming method where the first SiO₂layer 13 is directly provided on the ITO layer 12 as shown FIG. 1. The first Nb₂O₅ layer 23 plays an essential role to enhance film strength.

Thereafter, the first SiO₂ layer 24 having a thickness of about 28 nm to 29 nm is deposited on the first Nb₂O₅ layer 23 by using a silicon target in an atmosphere including Ar and oxygen with flow rates of, e.g., 150˜400 sccm and 120 sccm, respectively.

The second Nb₂O₅ layer 25 is deposited on the first SiO₂ layer 24 by using a Nb target in the atmosphere as in the first Nb₂O₅ layer 23. The thickness of the second Nb₂O₅ layer 25 is preferably about 112 nm.

In a final step, the second SiO₂ layer 26 is deposited on the second Nb₂O₅ layer 25 under the same condition as in the first SiO₂ layer 24. The thickness of the second SiO₂ layer 26 is preferred to be approximately 90 nm.

Accordingly, a multilayer structure having 5 layers as shown in FIG. 2 is constructed through the above-described processing steps. The thickness of each layer is optimized to provide the lowest possible reflection.

The multilayer structure for display device having 5 layers on a glass substrate in accordance with the present invention is strong enough to sustain impacts of strength of 1.5 kgF/cm² more than 2000 times. Specifically, the prior thin film having 4 layers structure shown in FIG. 1 can withstand impacts of strength of 1.5 kgF/cm² only about 150 times as described above; but the inventive structure having 5 layers on a glass substrate is durable against impacts of strength of 1.5 KgF/cm² for more 1000 times even in the case where the ordinary glass is used as the substrate as in the prior art film, and has a superior durability to sustain against impacts of strength of 1.5 KgF/cm² for about 2000 times when the surface-treated glass is used as the glass substrate 21 as described above.

That is, even when the glass substrate 21 is an ordinary glass, the 5 layered structure fabricated in accordance with the present invention can attain superior film strength compared to the conventional 4 layered film; and when the surface-treated glass is used as the glass substrate, the strength of the structure increases tremendously. And also, a thin film having the 5 layers structure of the present invention has a much improved optical property, i.e., a reduced photoreflectance of 0.13%, compared to the photoreflectance of 0.27% of the prior art 4 layered film structure.

While the invention has been shown and described with respect to the preferred embodiments, it will be understood by those skilled in the art that various changes and modifications may be made without departing from the spirit and scope of the invention as defined in the following claims.

What is claimed is:

1. An anti-reflective and anti-static structure for a display device, comprising a glass substrate, and an ITO layer, a first Nb₂O₅ layer, a first SiO₂ layer, a second Nb₂O₅ layer, and a second SiO₂ layer successively formed in that order on the glass substrate.

2. The structure of claim 1, wherein the ITO layer has a thickness of about 17˜19 nm.

3. The structure of claim 1, wherein the first Nb₂O₅ layer has a thickness of about 3˜5 nm.

4. The structure of claim 1, wherein the first SiO₂ layer has a thickness of about 28˜29 nm.

5. The structure of claim 1, wherein the second Nb₂O₅ layer has a thickness of about 112 nm.

6. The structure of claim 1, wherein the second SiO₂ layer has a thickness of about 90 nm.

7. The structure of claim 1, wherein the glass substrate has an average surface roughness of more than 2.10 Å and a peak-to-valley surface roughness of more than 40.1 Å.

8. The structure of claim 7, wherein the glass substrate has an average surface roughness of about 6.14 Å and a peak-to-valley surface roughness of about 106 Å.

9. The structure of claim 3, wherein the glass substrate has an average surface roughness of more than 2.10 Å and a peak-to-valley surface roughness of more than 40.1 Å.

10. The structure of claim 9, wherein the glass substrate has an average surface roughness of about 6.14 Å and a peak-to-valley surface roughness of about 106 Å.
